(19) United States
(12) Patent Application Publication
(10) Pub. No.: US 2019/0322575 A1
(43) Pub. Date: Oct. 24, 2019

(54) HIGH-STRENGTH SURFACE TREATMENT FOR GLASS AND METHOD FOR MAKING SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: YU-TSAI WANG, New Taipei (TW); JIAN-FEI JI, Shenzhen (CN); SHUI-YING CHEN, Shenzhen (CN); YONG-HONG SUN, Shenzhen (CN)

(21) Appl. No.: 16/058,432

(22) Filed: Aug. 8, 2018

(30) Foreign Application Priority Data
Apr. 18, 2018 (CN) 201810349897.7

(51) Int. Cl. C03C 17/32; B33Y 10/00; B33Y 70/00; B33Y 80/00

(52) U.S. Cl. CPC C03C 17/322; B33Y 10/00; B33Y 70/00; C03C 2218/365; C03C 2217/78; C03C 2218/13; B33Y 80/00

(57) ABSTRACT

A surface treatment applied to a glass which reduces breakability of the glass includes a substrate and a toughened layer formed thereon. The toughened layer of the disclosure is formed on at least one surface of the substrate. The toughened layer is an optical-grade nano resin film which has no significant effect on the transparency or color of the substrate. The disclosure further provides a method for applying the toughened layer on the glass.

### FIELD

The subject matter herein generally relates to glass covers.

### BACKGROUND

Electronic devices such as mobile phones and tablets are easily damaged when dropped, and there is a high risk that the screen or the glass cover of the electronic device may break because the screen or cover is made of glass, which is fragile.

### BRIEF DESCRIPTION OF THE DRAWINGS

Implementations of the present technology will now be described, by way of example only, with reference to the attached figures.

FIG. 1 is a cross-sectional view of an exemplary embodiment of a glass.

FIG. 2 is a cross-sectional view of another exemplary embodiment of a glass.

FIG. 3 is a flow chart of a method for making a glass in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Further, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

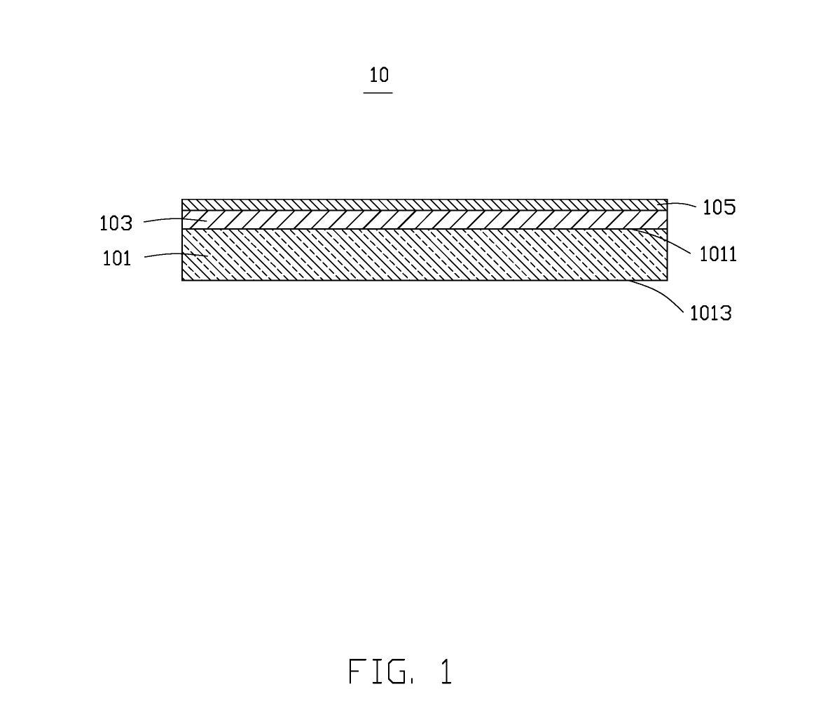

FIG. 1 illustrates a glass 10 according to an exemplary embodiment. The glass 10 can be used as a screen or a back cover of an electronic device. The electronic device can be, but not limited to, a mobile phone, a tablet, a personal digital assistant, or a smartwatch.

The glass 10 at least includes a substrate 101 and a toughened layer 103.

The substrate 101 includes an upper surface 1011 and a lower surface 1013. The upper surface 1011 and the lower surface 1013 are on two opposite sides of the substrate 101. The substrate 101 can be made of one of wire glass, sandwich glass, and tempered glass. In present embodiment, the substrate 101 is made of tempered glass.

The toughened layer 103 is formed on a surface of the substrate 101. For example, the toughened layer 103 can be formed on either the upper surface 1011 or the lower surface 1013 of the substrate 101. The toughened layer 103 increases the toughness of the glass 10 to reduce the chance of breaking the glass 10. The toughened layer 103 has a thickness of about 3-5 um, which does not affect light transmittance of the substrate 101.

In present embodiment, the toughened layer 103 is formed on the upper surface 1011 of the substrate 101 by toughening treatment. The toughening treatment can be carried out by continuous automatic 3D printing technique to print an optical-grade nano resin on the substrate 101, thereby forming the toughened layer 103 on the upper surface 1011 of the substrate 101.

In present embodiment, the optical-grade nano resin is a modified polyurethane, and the modified polyurethane has gloss properties, flexibility, and tensile strength. When the modified polyurethane is coated on the upper surface 1011 of the substrate 101 to form the toughened layer 103, the light transmittance of the substrate 101 is unaffected. The toughened layer 103 made of the modified polyurethane also has low shrinkage properties, which promotes adherence to the substrate 101.

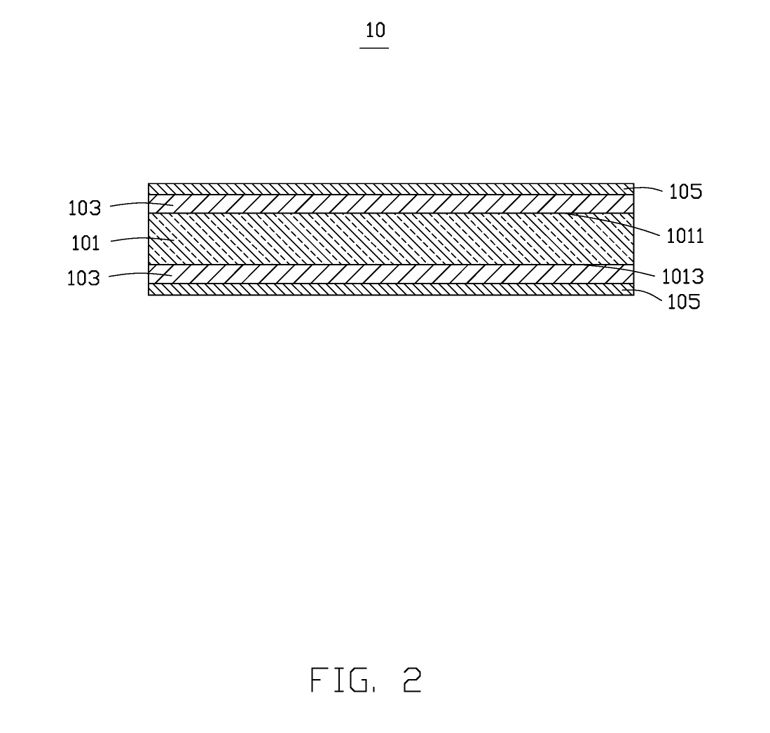

Referring to another embodiment in FIG. 2 to further improve the strength of the substrate 101, the toughened layer 103 can formed both on the upper surface 1011 and the lower surface 1013 of the substrate 101.

In another embodiment, a decorative film 105 can also be applied. The decorative film 105 is formed on the toughened layer 103. The decorative film 105 can be a color layer, or patterns and markings can be formed thereon. The decorative film 105 can be formed on the surface of the toughened layer 103 by coating technology, exposure, and development technology or sublimation. The decorative film 105 can enrich the appearance and visual appeal of the electronic device.

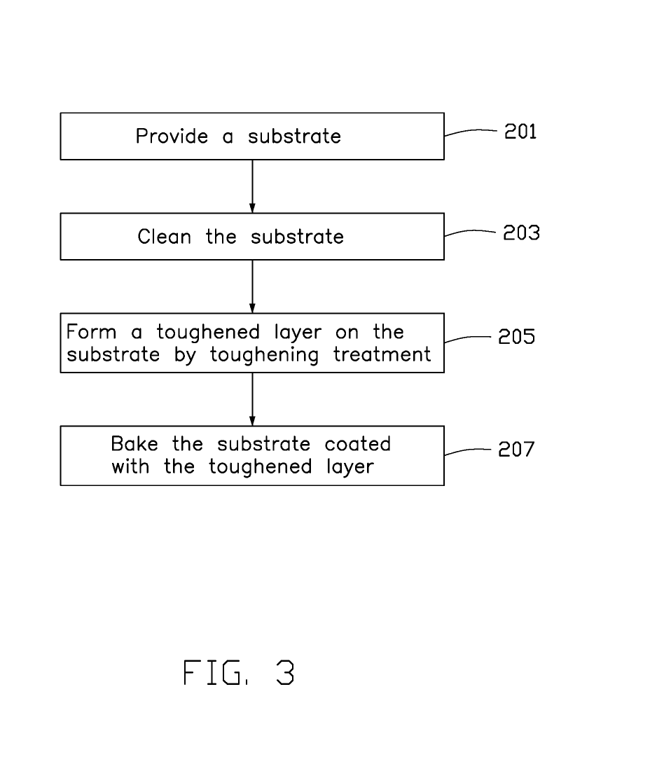

Referring to FIG. 3, a method for making a glass 10 is also provided. The method includes the following steps:

At block 201, provide a substrate 101. The substrate 101 includes an upper surface 1011 and a lower surface 1013. The upper surface 1011 and the lower surface 1013 are on two opposite sides of the substrate 101. The substrate 101 can be made of one of wire glass, sandwich glass, and tempered glass. In present embodiment, the substrate 101 is made of tempered glass.

At block 203, clean the substrate 101. In present embodiment, the cleaning process includes dipping the substrate 101 in a degreasing solution, and then dipping the substrate 101 in a pure water. The degreasing solution removes contaminants on the surface of the substrate 101.

Clean the substrate 101 by surface treatment technology. In present embodiment, the surface treatment technology can improve the adhesion of the substrate 101. The surface treatment technology also can remove organic matter on the surface of the substrate 101. The surface treatment technology can be plasma treatment technology.

At block 205, form a toughened layer 103 on the substrate 101 by toughening treatment. The toughened layer 103 increases the toughness of the glass 10 to reduce the chance of breaking the glass 10. The toughened layer 103 has a thickness of about 3-5 um which does not affect light transmittance of the substrate 101.

Specifically, the toughening treatment can be carried out by continuous automatic 3D printing technique to print an optical-grade nano resin on the substrate 101, thereby forming the toughened layer 103 on either the upper surface 1011 or the lower surface 1013 of the substrate 101.

In present embodiment, the optical-grade nano resin is a modified polyurethane, and the modified polyurethane has gloss properties, flexibility, and tensile strength.

In another embodiment, the toughened film 103 can be applied to both the upper surface 1011 and the lower surface 1013 of the substrate 101.

At block 207, bake the substrate 101 coated with the toughened layer 103. The baking process includes steps as follows: putting the substrate 101 with the toughened layer 103 into a drying apparatus, and drying it at 150° C. for 30 minutes to remove the solvent and moisture. During the baking process, the baking time of the toughened layer 103 must be controlled. When the baking time is too short, moisture and solvent on the surface of the toughened layer 103 are not completely volatilized, so that the surface of the toughened layer 103 is not completely cured. The bonding properties of the substrate 101 and the toughened layer 103, and the wear resistance of the toughened layer 103, would be adversely affected. When the baking time is too long, brittleness of the toughened layer 103 increases, and again affecting bonding between the substrate 101 and the toughened layer 103, and the breakability of the glass 10. The baking time is too short which means the baking time is less than 30 minutes. The baking time is too long which means the baking time is more than 30 minutes.

A falling ball test (ball weight: 65 g) was performed on the substrate 10 and the glass 10.

When the falling ball test height is set to 10 cm, neither the substrate 101 nor the glass 10 is cracked.

When the falling ball test height was set to 15 cm, the substrate 101 is cracked. The glass 10 is crack-free.

When the falling ball test height was set to 17 cm, the glass 10 was slightly indented.

When the falling ball test height is set to 20 cm, the glass 10 is cracked.

A light transmittance test of the substrate 101 and the glass 10.

The light transmittance of the substrate 101 is 92.11%. The light transmittance of the glass 10 is 91.87%.

A reliability of the glass 10:

The glass 10 has a very low degree of yellowing. In other words, the difference in the color of the glass 10 is small.

According to the above tests, the toughness of the glass 10 obtained after treating the substrate 101 is significantly improved. At the same time, the toughened layer 103 has little effect on the substrate 101 itself.

In another embodiments, a decorative film 105 can also be formed on the toughened layer 103 to meet different visual or aesthetic requirements. The decorative film 105 can be a color layer, letters or symbols formed thereon. The decorative film 105 can be formed on the toughened layer 103 by coating technology, exposure, and development technology, or sublimation. The decorative film 105 can enrich the appearance and visual appeal of the electronic device.

In summary, the glass 10 forms the toughened layer 103 on the surface of the substrate 101. The toughened layer 103 thereby improves the smoothness of the glass 10. In addition, the toughened layer 103 is an optical-grade material, and is formed on the surface of the substrate 101 by continuous automatic 3D printing technique. This process is simple, safe, and environmentally friendly.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A glass comprising:
a substrate; and
a toughened layer formed on at least one surface of the substrate, wherein the toughened layer is an optical-grade nano resin film.

2. The glass of claim 1, wherein the toughened layer has a thickness of about 3-5 um.

3. The glass of claim 1, wherein the toughened layer is formed by continuous automatic 3D printing technique to print an optical-grade nano resin on at least one surface of the substrate.

4. The glass of claim 1, wherein the glass further comprises a decorative film, the decorative film is formed on the toughened layer.

5. The glass of claim 4, wherein the decorative film is one of a color layer, letters and symbols.

6. The glass of claim 4, wherein the decorative film is formed on the toughened layer by one of coating technology, exposure and development technology, and sublimation.

7. The glass of claim 1, wherein the substrate is made of one of wire glass, sandwich glass and tempered glass.

8. A method for making a glass comprising:
providing a substrate; and
applying an optical-grade nano resin, a toughened layer is formed on at least one surface of the substrate by toughening treatment.

9. The method of claim 8, wherein the toughened layer has a thickness of about 3-5 um.

10. The method of claim 8, wherein the toughening treatment is carried out by continuous automatic 3D printing technique to print an optical-grade nano resin on at least one surface of the substrate.

11. The method of claim 8, wherein the method for making a glass further comprising:
putting the substrate with the toughened layer into a drying apparatus, and drying the substrate at 150° C. for 30 minutes to remove the solvent and moisture on the surface of the toughened layer.

12. The method of claim 8, wherein the method for making a glass further comprising:
forming a decorative film on the toughened layer by one of coating technology, exposure and development, and sublimation.

13. The method of claim 8, wherein the optical-grade nano resin is a modified polyurethane.

14. The method of claim 12, wherein the decorative film is one of a color layer, letters and symbols.

15. The glass of claim 8, wherein the substrate is made of one of wire glass, sandwich glass and tempered glass.
